(19) United States
(12) Patent Application Publication
(10) Pub. No.: US 2004/0210530 A1
(43) Pub. Date: Oct. 21, 2004

(54) Electronic money remittance method

(76) Inventors: Hiroki Mitsumoto, Kawasaki (JP); Hidetoshi Tamura, Kawasaki (JP)

Correspondence Address: ARMSTRONG, KRATZ, QUINTOS, HANSON & BROOKS, LLP, 1725 K STREET, NW, SUITE 1000, WASHINGTON, DC, 20006, US

(21) Appl. No.: 10/665,733

(22) Filed: Sep. 22, 2003

Related U.S. Application Data
(63) Continuation of application No. PCT/JP01/02195, filed on Mar. 19, 2001.

(51) Int. Cl. G06F 17/60

(52) U.S. Cl. 705/42

(57) ABSTRACT

In an electronic money system, based on an electronic money remittance order from a remitter's user terminal, an electronic mail including a predetermined remittance deposit program attached thereto is transmitted to a remittee's user terminal. At this time, an electronic money amount equivalent to the remittance is subtracted from the balance stored in an IC card, which is owned by the remitter and connected to the remitter's user terminal. The electronic money remitted to the remittee is deposited and stored into the IC card owned by the remittee through the execution of the remittance deposit program having been received in the terminal which is connected to the IC card owned by the remittee.

### FIELD OF THE INVENTION

The present invention relates to an electronic money system, and more particularly an electronic money remittance method in a closed-loop electronic money system.

### BACKGROUND ARTS

Electronic money is broadly classified into two types: a closed-loop type in which transfer of issued electronic money between individuals is prohibited and, inevitably, the issued electronic money flows back to the banks through the stores; and an open-loop type in which any desired amount of electronic money can be transferred between the users like hard cash. Referring to FIGS. 13 and 14, transaction processing of the closed-loop electronic money will be described hereafter.

FIG. 13 shows a diagram illustrating a transaction processing for depositing (paying-in) electronic money (hereafter referred to as deposit transaction processing) related to the closed-loop electronic money system. In FIG. 12, the closed-loop electronic money is normally issued under the guarantee of each user's account in a bank or credit allowed by a credit company. In FIG. 13, an exemplary case of guarantee by the bank account is illustrated.

The electronic money system includes an electronic money server 20 and cooperates with a bank accounting system 10 and an electronic money deposit machine 30. Bank accounting system 10 performs banking routines such as receipt and payment against users' bank accounts, response to account balance inquiry, and fund transfer to other users' bank accounts. The electronic money system is normally constituted of a general-purpose computer, and is provided with a database for managing users' bank accounts and balance accounts of electronic money deposited in users' IC cards.

Electronic money server 20 is constituted of electronic money generator 21, transaction controller 22, transaction data manager 23, bank account system cooperation section 24, and electronic money balance management database 25 which manages the balances of the electronic money on a user's card-by-card basis. In general, electronic money server 20 is constituted of PC server, UNIX server, or the like.

Electronic money deposit machine 30 is a terminal operated by each user when the user wants to deposit electronic money into the user's IC card in which electronic money is stored. Electronic money deposit machine 30 is constituted of a specially designed terminal for depositing electronic money, or an automatic teller machine (ATM) in which an electronic money deposit function is additionally incorporated.

The IC card is formed of a plastic card of a credit card size, having an IC chip mounted thereon, including CPU, co-processor for encryption/decryption operation, RAM and ROM. The IC card includes an encryption key for achieving secure transmission of transaction data, a certificate certifying the authenticity of the card, and a cipher program for performing mutual authentication between an upper-level system, as well as electronic money data.

Now, hereafter a typical transaction processing for depositing electronic money paid in (which is simply referred to as ‘deposit transaction processing’) in electronic money system will be described.

(1) First, a user inserts an IC card into electronic money deposit machine 30, selects ‘deposit transaction’, and inputs the code number for the IC card and the amount paid in from the input unit of electronic money deposit machine 30.

(2) Based on the input data from the user, electronic money deposit machine 30 issues an instruction to transaction controller 22 in electronic money server 20 to execute electronic money deposit transaction with the user's IC card.

(3) On receipt of the electronic money deposit transaction instruction from electronic money deposit machine 30, transaction controller 22 in electronic money server 20 checks the user's bank account balance by inquiring to bank accounting system 10 through bank account system cooperation section 24.

(4) As a result of checking the user's bank account balance, if the account balance is no less than the amount ordered by the user to be paid in, transaction controller 22 in electronic money server 20 issues an instruction to electronic money generator 21 to initiate the processing.

(5) Electronic money generator 21, thus initiated by transaction controller 22 of electronic money server 20, accesses the user's IC card inserted in electronic money deposit machine 30, and updates the electronic money balance in the IC card based on the amount ordered by the user to be paid in.

(6) After the balance update processing is successfully completed in electronic money generator 21 of electronic money server 20, the IC card transmits a completion notification to transaction controller 22.

(7) On receiving the balance update completion notification from the IC card, transaction controller 22 of electronic money server 20 issues to bank accounting system 10 an instruction of fund transfer from the user's bank account to an electronic money management account through bank account system cooperation section 24. The electronic money management account is dedicatedly prepared for managing the electronic money balance stored in each IC card. In an ordinary electronic money system, electronic money is issued under the guarantee of the user's bank account balance. At the time of issuing the electronic money, the amount of the electronic money issued and stored in the IC card, which becomes the electronic money balance at that time, is transferred from the user's bank account to the electronic money management account of the user concerned.

(8) At the same time, transaction controller 22 in electronic money server 20 generates the deposit transaction data, and transmits the generated deposit transaction data to transaction data manager 23. Information included in the deposit transaction data are; transaction type (deposit), transaction serial number, card number, transaction amount of money, identifier of the terminal through which the transaction is carried out, date/time of the transaction, etc.

(9) Transaction data manager 23 in electronic money server 20 updates the balance data in electronic money balance management database 25 according to the deposit transaction data transmitted from transaction controller 22. Thus the deposit processing is completed.

Next, referring to FIG. 14, a payment transaction processing will be described hereafter. In FIG. 14, as is similar to FIG. 13, an example of electronic money guaranteed by the bank account balance is illustrated. The electronic money system is constituted of bank accounting system 10, electronic money server 20, electronic money POS terminal 50 (simply referred to as electronic money POS 50), and IC card. Electronic money POS 50 is a terminal installed in a store to accept payment by the electronic money stored in the IC card. This POS is implemented either using a dedicatedly designed terminal for electronic money payment, or a POS terminal having an electronic money function by additionally incorporating the function into an ordinary POS terminal.

A typical payment transaction processing will be described below.

(1) An operator in a store inserts a user's IC card into electronic money POS 50, and manually inputs a payment amount. Or, alternatively, the payment amount data is transferred from an upper-level system.

(2) When the user agrees to pay, inputs a code number when necessary, and thereafter depresses ‘OK’ button (not shown) provided on electronic money POS 50, electronic money POS 50 accesses the IC card and updates the electronic money balance in the IC card according to the payment amount input in the above (1).

(3) After updating the electronic money balance in the IC card, electronic money POS 50 generates a payment transaction data, which is transmitted to transaction data manager 23. The data included in the payment transaction data are; transaction type (‘payment’), transaction serial number, card number, transaction amount of money, identifier of the terminal through which the transaction is carried out, transaction date/time, etc.

(4) Transaction data manager 23 in electronic money server 20 updates the balance data stored in electronic money balance management database 25 according to the payment transaction data received from electronic money POS 50.

(5) At the same time, transaction data manager 23 in electronic money server 20 issues to bank accounting system 10 a fund transfer instruction from the electronic money management account to a bank account of the store through bank account system cooperation section 24. Thus the payment transaction is completed.

As having been described, in electronic money of closed-loop type, the issued electronic money is inevitably circulated back to the bank. The deposit transaction made with the IC card is possible only through the online transaction which is made with electronic money server 20. Further, the deposit transaction data or payment transaction data are entirely collected to electronic money server 20 and managed. Therefore, in the closed-loop electronic money system, it is relatively easy to detect any illegal conducts such as forgery of transaction data. However, in this closed-loop electronic money system, there is a defect that electronic money cannot be transferred (remitted) directly from one IC card owned by an individual to another IC card owned by a third party.

### DISCLOSURE OF THE INVENTION

It is an object of the present invention to provide a method for remitting electronic money, by which money can be transferred between the users even in a closed-loop electronic money system.

In order to attain the above-mentioned object, according to the present invention, the following electronic money remittance method is provided in an electronic money system. An electronic mail including a predetermined program for depositing the remittance (hereafter referred to as remittance deposit program) is transmitted to another user terminal of the remittee side, based on an electronic money remittance order from a user terminal of the remitter side. At this time, the electronic money amount equivalent to the remittance is subtracted from the balance stored in the IC card connected to the user terminal of the remitter side. The remittee then executes the remittance deposit program received by the terminal on the remittee side to which the remittee's IC card is connected. Thus, the electronic money is transferred from the electronic money system and deposited in the remittee's IC card.

Preferably, an electronic money remittance method for remitting electronic money from a first user to a storage means storing electronic money of a second user includes; receiving predetermined remittance order information from a terminal for use by the first user; based on the remittance order information, generating a program for depositing an electronic money amount equivalent to the remittance into the storage means of the second user, and subtracting the amount equivalent to the remittance from a predetermined account balance related to the first user; transmitting the program to a terminal for use by the second user; receiving a remittance instruction transmitted from the terminal for use by the second user as a consequence that the program received by the terminal for use by the second user is executed by the aforementioned terminal; and according to the remittance instruction, depositing an electronic money amount equivalent to the remittance by accessing the storage means of the second user connected to the terminal for use by the second user, and adding the amount equivalent to the remittance an electronic money management account balance related to the electronic money stored in the storage means of the second user.

Further scopes and features of the present invention will become more apparent by the following description of the embodiments with the accompanied drawings.

### BRIEF DESCRIPTION OF THE DRAWINGS

FIG. 1 shows a configuration example of an electronic money system according to an embodiment of the present invention.

FIG. 2 shows a flowchart illustrating a first remittance processing in the electronic money system according to the embodiment of the present invention.

FIG. 3 shows a diagram illustrating a variety of data flows including those between the functional units in the first remittance processing.

FIG. 4 shows a diagram illustrating a variety of data flow including the flow between the functional units in the first remittance processing.

FIG. 5 shows an example of a screen displayed on a display unit of a terminal 70A.

FIG. 6 shows a diagram illustrating a file example stored in a database 25.

FIG. 7 shows a diagram illustrating an account management method in a bank accounting system 10.

FIG. 8 shows a diagram illustrating the transfer of electronic money in the first remittance processing.

FIG. 9 shows a flowchart illustrating a second remittance processing in the electronic money system according to the embodiment of the present invention.

FIG. 10 shows a diagram illustrating a variety of data flow including the flow between the functional units in the second remittance processing.

FIG. 11 shows a diagram illustrating a variety of data flow including the flow between the functional units in the second remittance processing.

FIG. 12 shows a diagram illustrating the transfer of electronic money in the second remittance processing.

FIG. 13 shows a diagram illustrating a deposit transaction processing in the closed-loop electronic money system.

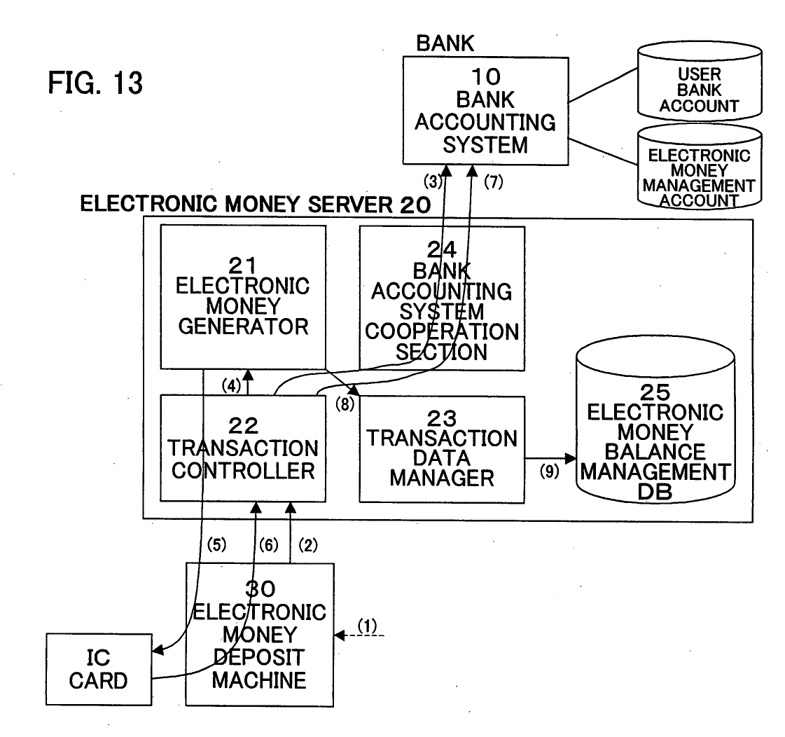

FIG. 14 shows a diagram illustrating a payment transaction processing in the closed-loop electronic money system.

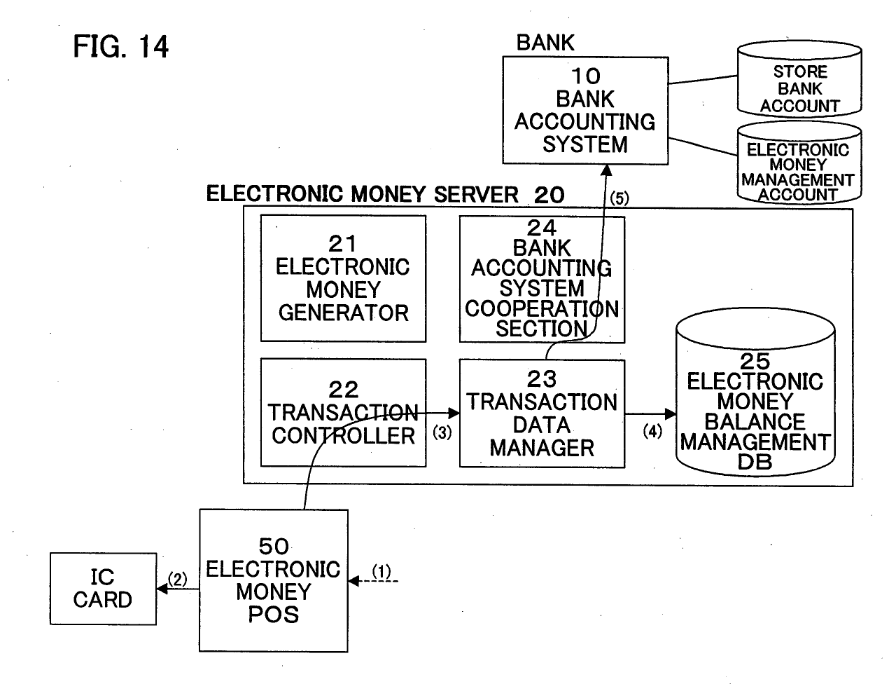

### THE PREFERRED EMBODIMENTS OF THE INVENTION

The preferred embodiment of the present invention is described hereinafter referring to the charts and drawings. However, it is to be noted that the scope of the present invention is not limited to the embodiments described below.

According to the embodiment of the present invention, electronic money remittance between the users of a closed-loop electronic money system is achieved by use of an electronic mail cooperating with an electronic money transaction processing.

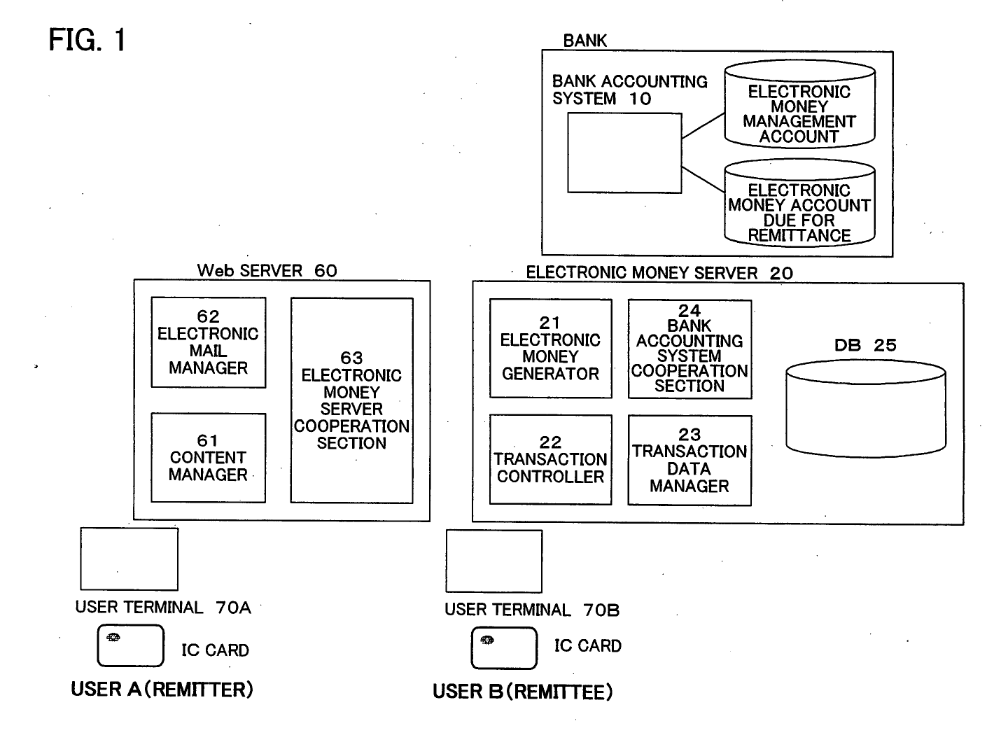

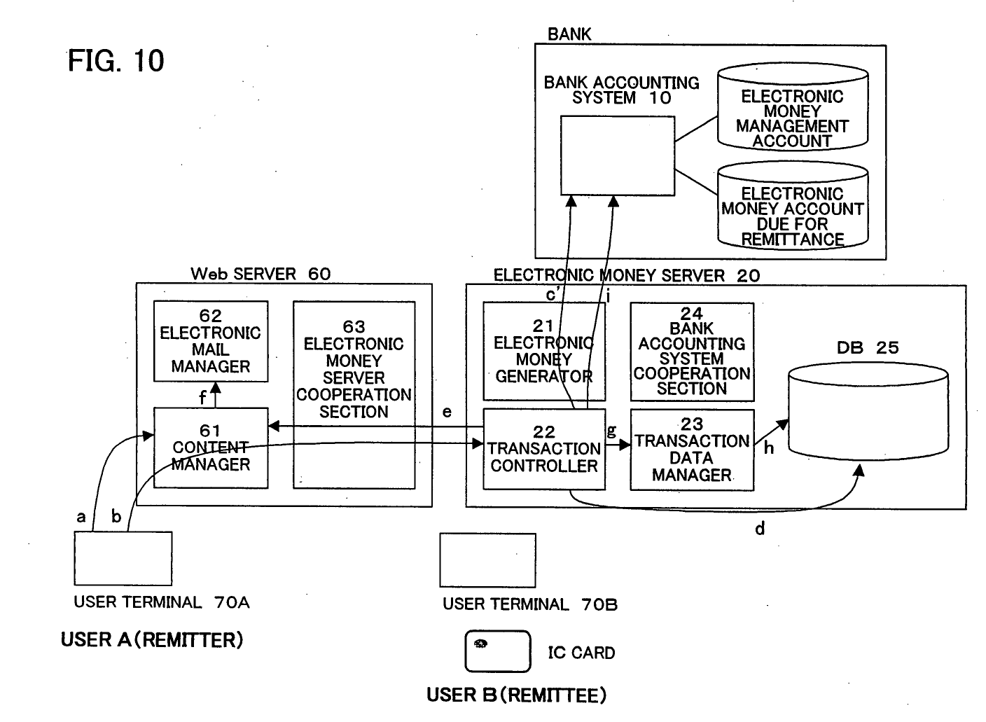

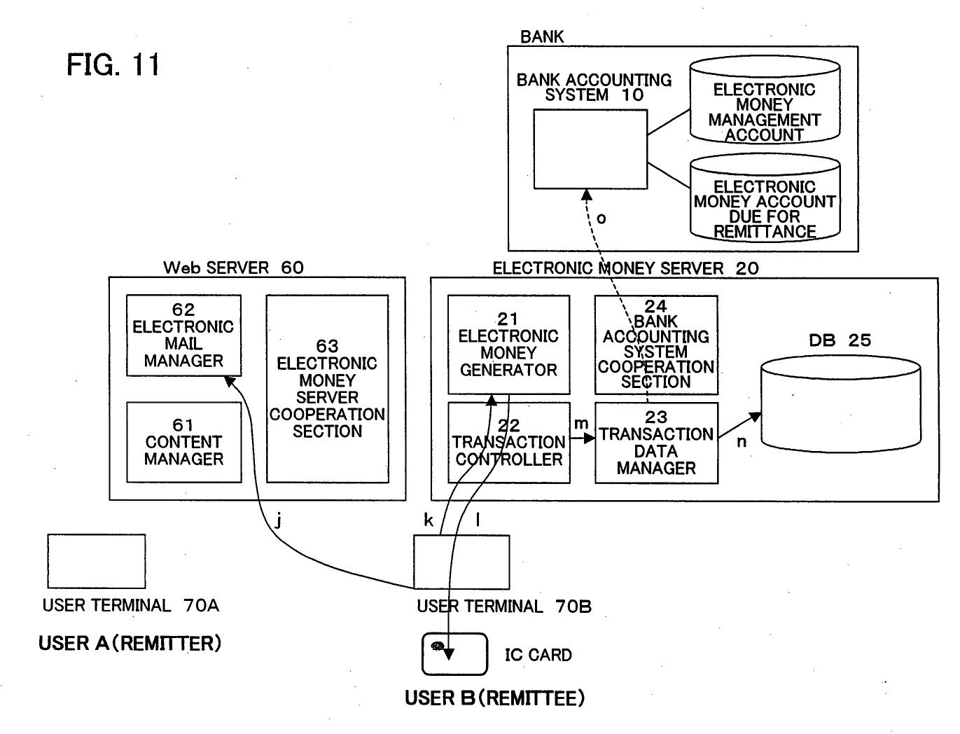

FIG. 1 shows a configuration example of the electronic money system in accordance with an embodiment of the present invention. In FIG. 1, the electronic money system is provided with an electronic money server 20 and a Web server (network server) 60. The electronic money system cooperates with a bank accounting system 10 and each user terminal 70A (70B). Bank accounting system 10 and electronic money server 20 includes identical function portions shown in FIGS. 10, 11. In these figures, an identical reference number is assigned to each identical portion. Further, in the bank having the accounting system, an electronic money account due for remittance, which will be describe later, is opened, in addition to a user's bank account and an electronic money management account for managing theuser's electronic money balance.

Web server 60 is a server which offers an electronic money remittance service to the users. For this purpose, Web server 60 provides an electronic money remittance application site on a network such as the Internet. Web server 60 includes a content manager 61 which manages content data (HTML files) to be displayed onto user terminal 70, an electronic mail manager 62 which temporarily stores an electronic mail and transmits/receives the electronic mail, and an electronic money server cooperation section 63.

User terminal 70 is provided with a display unit such as liquid crystal display (LCD), CRT display, or the like, an input unit such as a keyboard, and a read/write unit for reading/writing from/to an IC card in which electronic money is stored. User terminal 70 is connected to Web server 60 via a network. This user terminal 70 is also provided with a display function (browser) which displays the content data provided by Web server 60 onto the display unit, as well as an electronic mail edition function. Typically, user terminal 70 is constituted of a personal computer, a portable telephone, or the like.

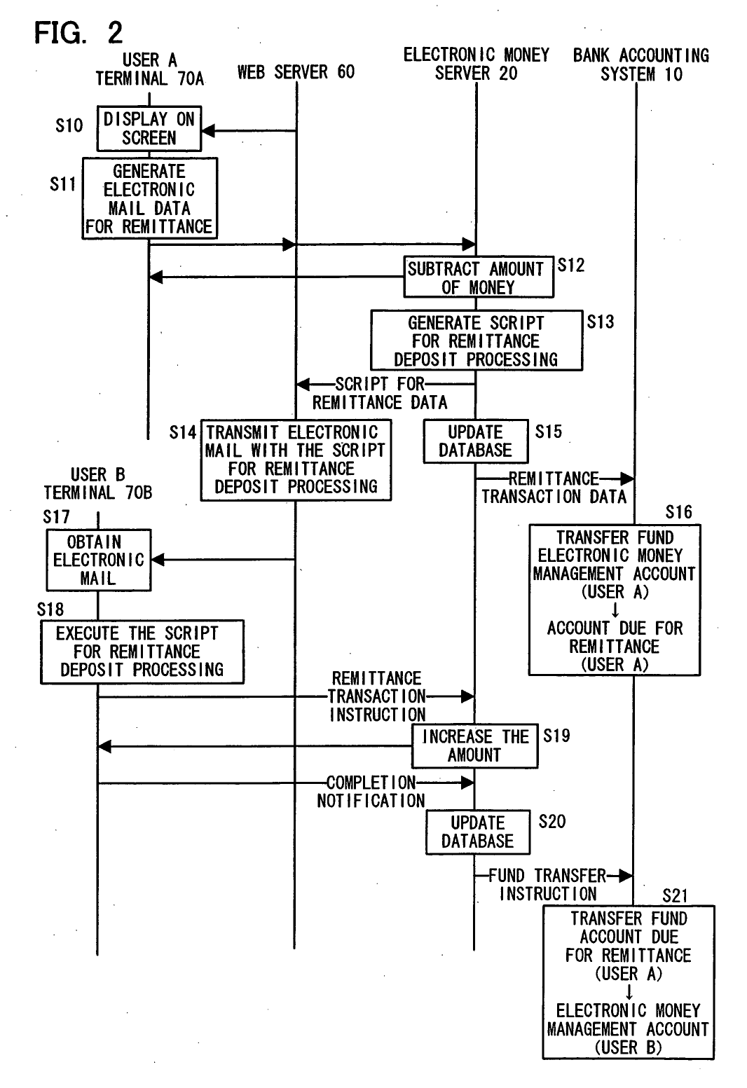

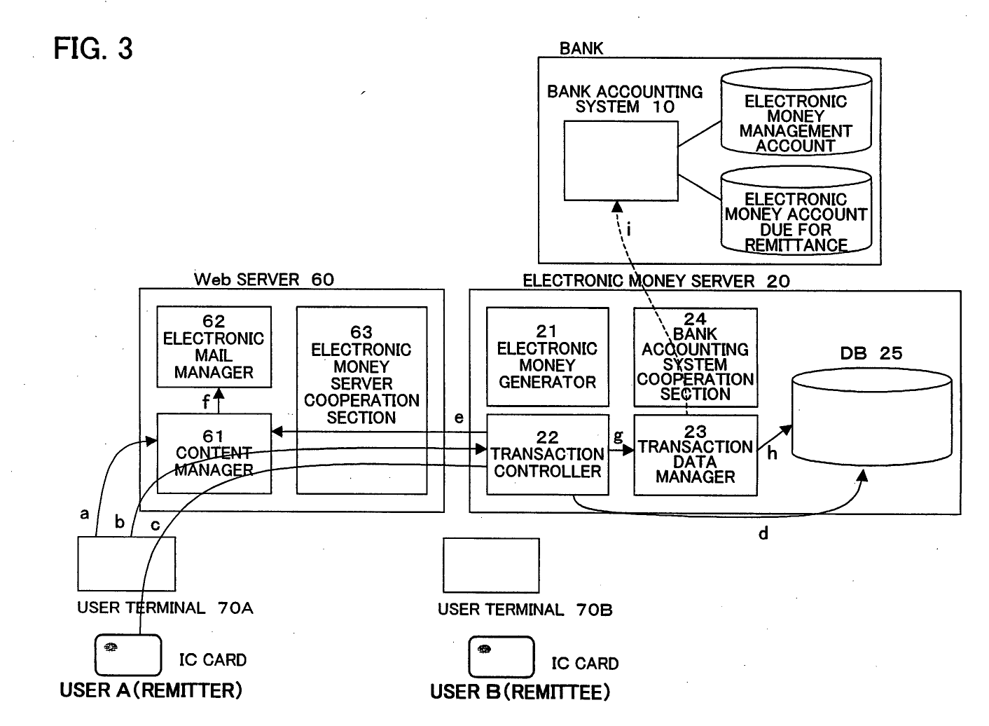

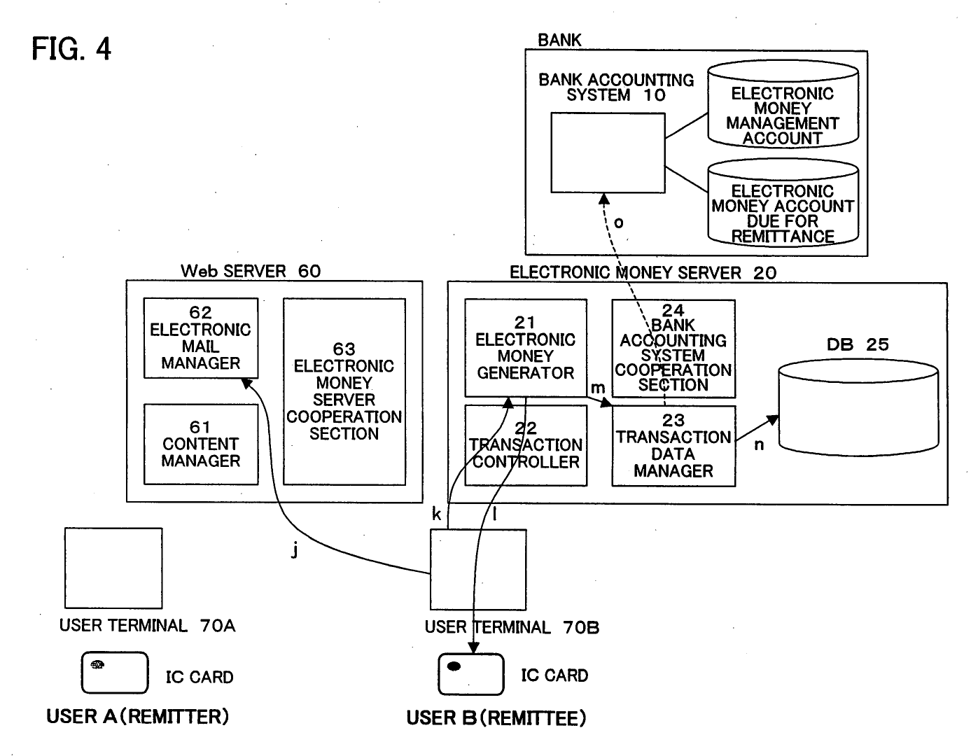

FIG. 2 shows a flowchart illustrating a first remittance processing in the electronic money system according to the embodiment of the present invention. Also, FIGS. 3 and 4 show diagrams illustrating a variety of data flow, for example, between each functional block in the first remittance processing. Now, FIG. 2 will be explained referring to FIGS. 3, 4. Hereafter, there is described a case that a user A remits the entire electronic money stored in the own IC card, or a portion of the electronic money, to another IC card owned by user B.

User A accesses Web server 60 through a wired or wireless network using terminal 70. (Refer to an arrow ‘a’ shown in FIG. 3. Only arrow symbols will be denoted hereafter.) A screen including the electronic money remittance service contents is then displayed onto the display unit. This screen is provided by Web server 60 (electronic money remittance application site) (S10).

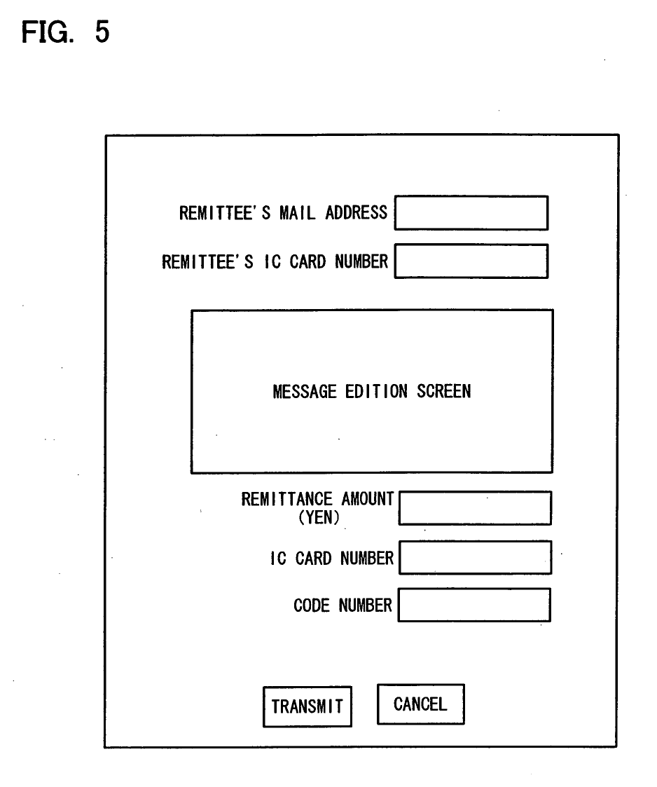

FIG. 5 shows an exemplary screen displayed on the display unit of terminal 70A. In FIG. 5, user A edits an electronic mail including a message addressed to user B. User A also inputs a remittance data including either the mail address of user B or the IC card number owned by user B, and a remittance amount. By use of these input data, an electronic mail data for remittance is generated (S11). After the completion of generating the electronic mail data for remittance, user A selects ‘Transmit’ button. As a result, the electronic mail data for remittance generated on the screen is transmitted to content manager 61 in Web server 60 (arrow ‘b’). On receipt of the electronic mail data for remittance, content manager 61 further transfers this electronic mail data for remittance to a transaction controller 22 in electronic money server 20 (arrow ‘b’). At the same time, the electronic mail data for remittance is preserved in content manager 61.

On receipt of the electronic mail data for remittance, transaction controller 22 in electronic money server 20 accesses the IC card connected to terminal 70A of user A via Web server 60 (arrow ‘c’), and subtracts electronic money equivalent to the amount input by user A (in FIG. 3) from the electronic money balance stored in the IC card (S12). Transaction controller 22 then generates a script for remittance deposit processing, so as to initiate a remittance deposit processing for transferring electronic money into the IC card of user B (S13).

The script for remittance deposit processing is an application program which enables the deposit of remitted electronic money into an IC card. The execution of this script activates electronic money generator 21 in electronic money server 20 to perform the above-mentioned remittance deposit function. The script includes such data as instruction type of ‘deposit of remittance’, destination of remittance (remittee), IC card number, remittance amount, and transaction serial number. The script is implemented in the form of, for example, Java applet.

Additionally, the electronic mail address of user B may be input in the electronic mail data for remittance, instead of the card number of the IC card owned by user B. In such a case, transaction controller 22 searches an IC card user table in a database 25 (arrow ‘d’) and obtains the IC card number of user B from the electronic mail address of user B.

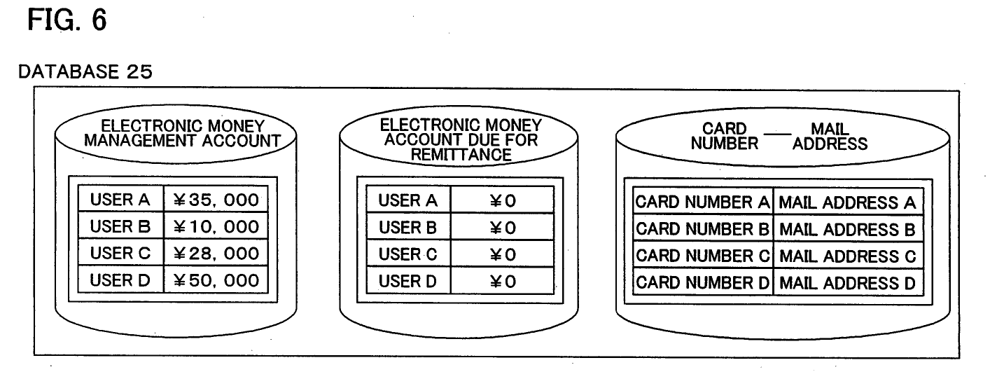

FIG. 6 shows a diagram illustrating an example of the file stored in database 25. In FIG. 6(a), database 25 includes an account balance table 251 for managing electronic money and an account balance table 252 for electronic money due for remittance. These account balance tables 251, 252 are provided on a user-by-user basis by use of each user's identification code (preferably IC card number). Moreover, database 25 includes a mapping table 253 which is indicative of the relation between the IC card number and the electronic mail address on a per user basis. Using database 25, the electronic money balance is managed against the electronic money management account on a per user basis, as well as the electronic money balance due for remittance is managed against the electronic money account due for remittance on a per user basis, as shown in FIG. 6.

Transaction controller 22 transmits the generated deposit script to content manager 61 of Web server 60 (arrow ‘e’). Content manager 61 transfers the received deposit script to electronic mail manager 62 by attaching a file to the electronic mail addressed to user B (arrow ‘f’). Electronic mail manager 62 then transmits the transferred electronic mail to the mail address of user B (S14).

Meanwhile, transaction controller 22 in electronic money server 20 generates a remittance transaction data and transfers this data to transaction data manager 23 (arrow ‘g’). The remittance transaction data exemplarily includes transaction type of ‘remittance’, transaction serial number, card number of user A, transaction amount, and transaction date/time.

Based on the remittance transaction data, transaction data manager 23 subtracts the remittance amount from the electronic money management account balance of user A, which is managed in database 25, and performs processing of adding an amount equivalent to the remittance to the balance in the user A's electronic money account due for remittance (S15, arrow ‘h’). In such a way, the electronic money management account balance, which is managed by database 25, coincides with the electronic money management account balance actually set in the bank. Also, the account balance due for remittance which is managed using database 25 coincides with the balance in the electronic money account due for remittance actually set in the bank.

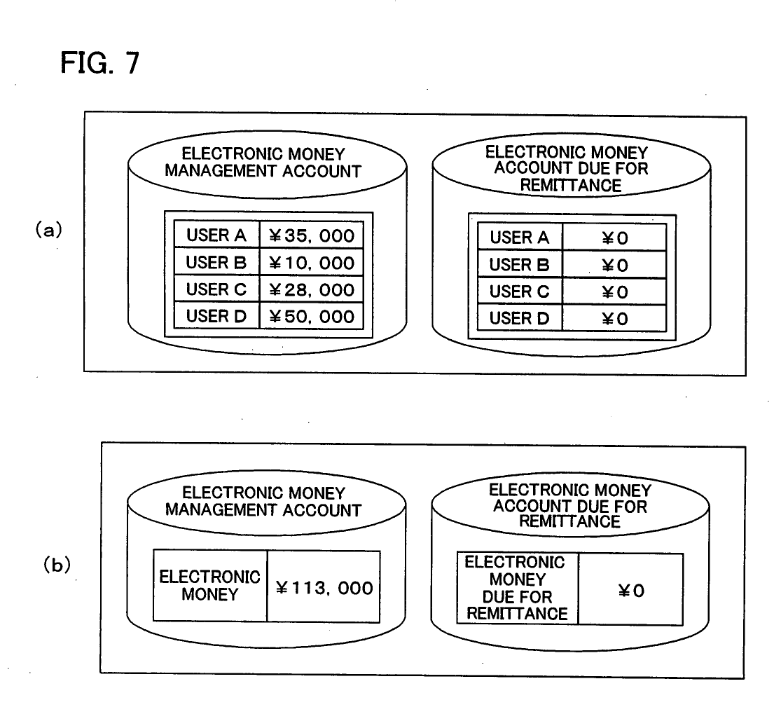

It is to be noted that the management method in bank accounting system 10 may be the same as mentioned above, or may be different: In bank accounting system 10, it may be possible to manage the electronic money balance and the electronic money balance due for remittance in the electronic money management account and the electronic money account due for remittance respectively on a per user basis, as shown in FIG. 7(a). Or, in a different manner, each balance may be managed integrally, not on a per user basis, as shown in FIG. 7(b).

Further, transaction controller 22 transmits the remittance transaction data to bank accounting system 10 through bank accounting system cooperation section 24 (arrow ‘i’). Based on the remittance transaction data, bank accounting system 10 transfers an electronic money amount equivalent to the remittance from electronic money management account of user A to electronic money account due for remittance of user A (S16).

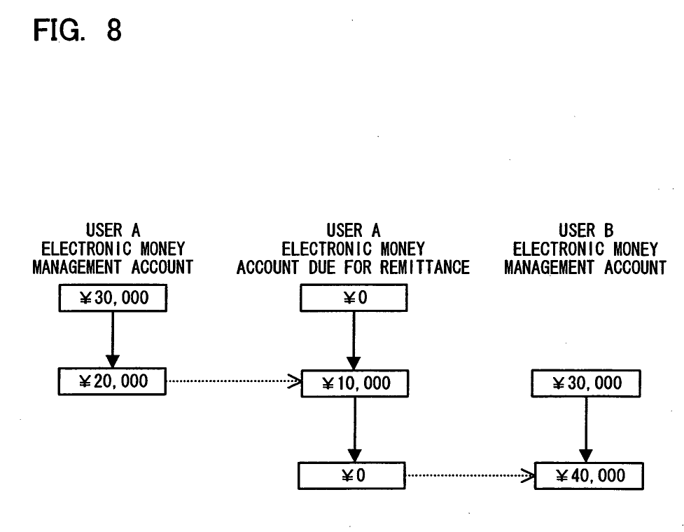

FIG. 8 shows a diagram illustrating electronic money transfer in a first remittance processing. In this FIG. 8, when remitting the electronic money for Yen 10,000 from user A to user B, Yen 10,000 is subtracted from the electronic money management account balance of user A, and Yen 10,000 is added to the user A's electronic money account due for remittance. Account balance tables 251, 252 in database 25 are updated as well.

An electronic mail addressed to user B is received by a server managing the mail address of user B, and the received electronic mail is kept in the server. In the following description, the aforementioned Web server 60 is illustrated as the server managing the electronic mail address of user B. However, needless to say, any other Web server may be applicable.

Terminal 70B of user B access Web server 60 through a wired or wireless network (arrow ‘j’ in FIG. 4. Hereafter, reference is made to FIG. 4.) Terminal 70B receives the electronic mail forwarded to the mail address of user B (S17). In the electronic mail sent from user A, the script for remittance deposit processing is attached, as mentioned earlier. Based on a predetermined operation by user B, terminal 70B executes the script for remittance deposit processing which is attached to the electronic mail (S18). In accordance with the execution of the script for remittance deposit processing, terminal 70B transmits an electronic money remittance transaction instruction to transaction controller 22 in electronic money server 20 (arrow ‘k’). This electronic money remittance transaction instruction includes information such as the IC card number of the remittee and the remittance amount.

On receipt of the electronic money remittance transaction instruction from terminal 70B, transaction controller 22 in electronic money server 20 initiates electronic money generator 21. Electronic money generator 21 accesses the IC card of user B connected to terminal 70B, and adds an amount equivalent to the remittance included in the electronic money remittance instruction to the electronic money balance stored in the IC card (S19, arrow ‘l’).

After electronic money generator 21 in electronic money server 20 successfully completes to update the balance, the IC card transmits a completion notification to transaction controller 22.

After receiving the balance update completion notification from the IC card, transaction controller 22 in electronic money server 20 generates a transaction data for depositing the remitted money, and transfers this transaction data to transaction data manager 23 (arrow ‘m’) The information included in the transaction data for depositing the remitted money are; a transaction type of ‘deposit of remittance’, transaction serial number, transaction amount, terminal identifier used for the transaction, transaction date/time, etc. The reason for providing the transaction type of ‘deposit of remittance’, which is different from the transaction type of ‘deposit’ for use in an ordinary deposit, is to distinguish the accounts from which fund transfer is originated: As mentioned above, the account of the fund transfer source in the case of ‘deposit of remittance’ is the user A's electronic money account due for remittance, whilst the fund transfer source in the case of the ordinary ‘deposit’ is the user B's bank account.

Transaction data manager 23 updates the balance table in database 25 based on the transaction data of ‘deposit of remittance’ (S20, arrow ‘n’).

Also, transaction controller 22 issues a fund transfer instruction to bank accounting system 10 to transfer from the user A's electronic money account due for remittance to electronic money management account of user B, through bank accounting system cooperation section 24. As such, based on the remittance transaction instruction, transaction controller 22 instructs the fund transfer from electronic money account due for remittance of user A, not from the bank account of user B which is initiated by the ordinary deposit transaction instruction. Thus, in accordance with the fund transfer instruction, bank accounting system 10 transfers an electronic money amount equivalent to the remittance from the user A's electronic money account due for remittance to the electronic money management account of user B (S21). As a result, the electronic money owned by user A is remitted to user B.

As shown in FIG. 8, Yen 10,000 is subtracted from the user A's electronic money account due for remittance which has been increased in the above-mentioned step S16, and this amount of Yen 10,000 is added to the electronic money management account of user B. Also, the amount in the balance table in database 25 is updated as well.

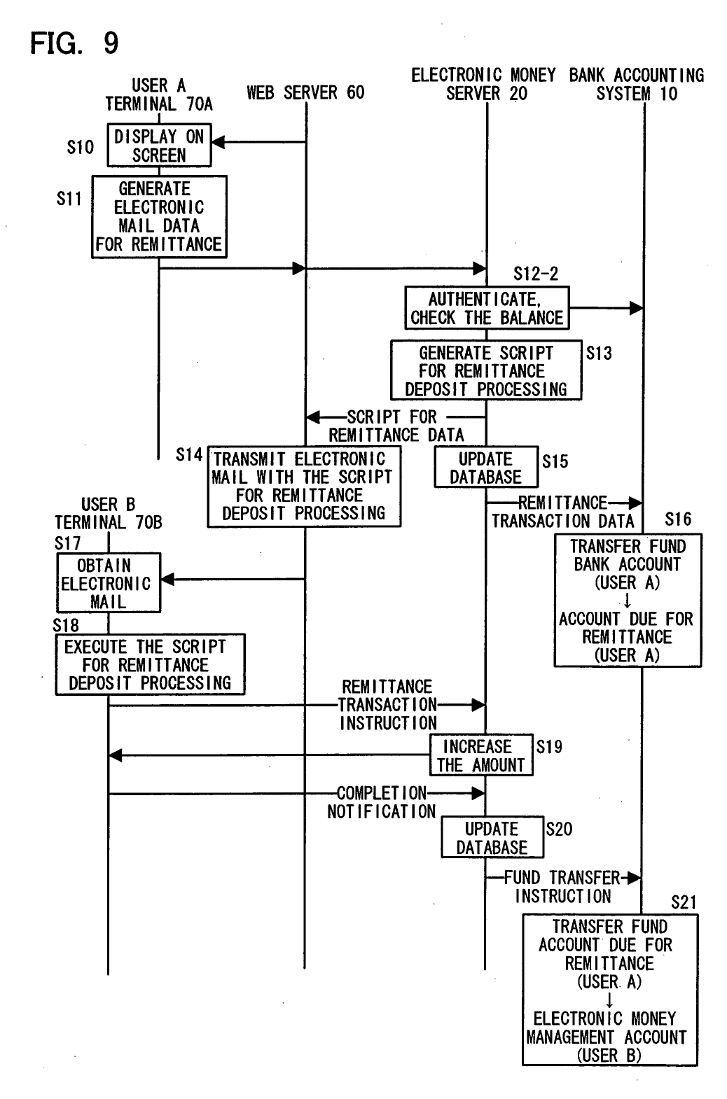

FIG. 9 shows a second remittance processing in the electronic money system according to the embodiment of the present invention. Further, FIGS. 10 and 11 show a variety of data flow between the function portions and the like in the second remittance processing. FIG. 9 is explained hereafter referring to FIGS. 10 and 11. Here, in this second remittance processing, electronic money is remitted from user A to user B in a similar manner to the above-mentioned first remittance processing. However, in this case, electronic money is transferred from user A having no IC card for storing electronic money to user B having an IC card, which is different from the first remittance processing. Hereinafter, the second remittance processing is described as compared with the aforementioned first remittance processing. Additionally, with regard to the processing steps in the second remittance processing shown in FIG. 9, identical reference numbers are assigned to the like steps in the first remittance processing.

User A accesses Web server 60 from terminal 70A through the wired or wireless network (arrow ‘a’ shown in FIG. 10. Hereafter only arrows are described.) An electronic money remittance service content screen provided by Web server 60 is displayed on the display unit (S10). Terminal 70A of user A may not be provided with the IC card read/write unit.

The user creates an electronic mail data for remittance by use of the above-mentioned screen shown in FIG. 5 (S11). After creating the electronic mail data for remittance, when user A selects ‘Transmit’ button, the electronic mail data for remittance generated on the screen is transmitted to content manager 61 in Web server 60. The electronic mail data is further transferred to transaction controller 22 in electronic money server 20 (arrow ‘b’). At this time, the electronic mail data for remittance includes the bank account number of user A and the code number thereof, in place of the IC card number of user A used in the first remittance processing.

On receipt of the electronic mail data for remittance, transaction controller 22 in electronic money server 20 accesses bank accounting system 10 through bank accounting system cooperation section 24 (arrow ‘c prime’). Transaction controller 22 then authenticates user A based on the code number, and verifies the bank account balance of user A (S12-2). After verifying that the bank account balance of user A is no less than the amount of remittance ordered by user A, transaction controller 22, generates a script for remittance deposit processing in a similar way to the aforementioned first remittance processing (S13).

Thereafter, also similarly to the first remittance processing, an electronic mail including the script for remittance deposit processing attached thereto is transmitted to the mail address of user B (S14).

Meanwhile, transaction controller 22 in electronic money server 20 generates a remittance transaction data, and transmits the generated remittance transaction data to transaction data manager 23. Based on the remittance transaction data, transaction data manager 23 performs processing of adding an amount equivalent to the remittance to the balance in the user A's electronic money account due for remittance which is maintained in database 25 (S15, arrow ‘h’).

Further, transaction controller 22 transmits the remittance transaction data to bank accounting system 10 through bank accounting system cooperation section (arrow ‘i’). Based on the remittance transaction data, bank accounting system 10 transfers an electronic money amount equivalent to the remittance from the bank account of user A to the user A's electronic money account due for remittance (S16). As such, according to the second remittance processing, a fund is transferred directly from the bank account of user A to the electronic money account due for remittance, because user A does not own an electronic money management account.

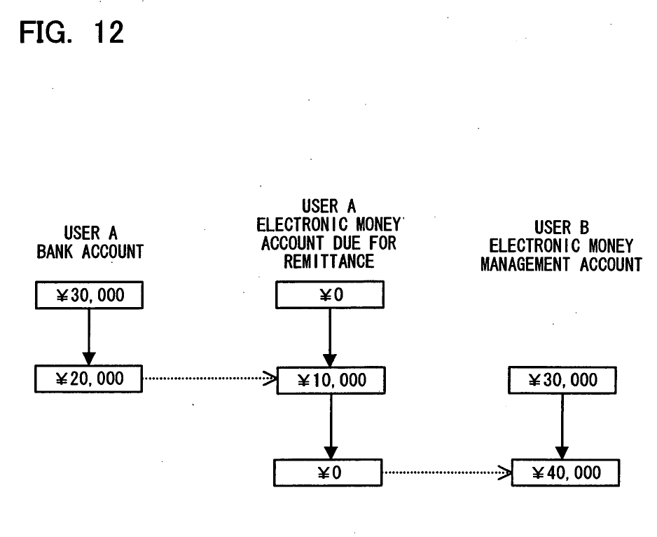

FIG. 12 shows a diagram illustrating the electronic money transfer in the second remittance processing. In FIG. 12, when user A orders to transfer electronic money for Yen 10,000 to user B, first Yen 10,000 is subtracted from the bank account of user A, and at the same time, Yen 10,000 is added to the user A's electronic money account due for remittance. If user A does not own an IC card., an electronic money management account balance table for user A is not provided in database 25, and therefore Yen 10,000 is added to an electronic money remittance balance table corresponding to an identifier other than the IC card number previously assigned to user A.

The second remittance processing on the user B side is the same as the first remittance processing mentioned above. Namely, terminal 70B of user B accesses Web server 60 through the wired or wireless network (arrow ‘j’ in FIG. 11. Hereafter the reference is made to FIG. 11). Terminal 70B receives an electronic mail addressed to the electronic mail address of user B (S17), and executes the remittance processing script attached to the received electronic mail (S18). As the remittance processing script is being executed, terminal 70B transmits an electronic money remittance transaction instruction to transaction controller 22 in electronic money server 20 (arrow ‘k’). In a similar way to the aforementioned first remittance processing, electronic money generator 21 in electronic money server 20 accesses the IC card of user B connected to terminal 70B, and adds an amount equivalent to the remittance included in the electronic money remittance instruction to the electronic money balance stored in the IC card (S19, arrow ‘l’).

Transaction controller 22 in electronic money server 20 generates a transaction data of ‘deposit of remittance’, and transfers this transaction data to transaction data manager 23 (arrow ‘m’). Transaction data manager 23 then updates the balance data in database 25 based on the transaction data of ‘deposit of remittance’ (S20, arrow ‘n’).

Also, transaction controller 22 in electronic money server 20 issues a fund transfer instruction to bank accounting system 10 to transfer from the user A's electronic money account due for remittance to the electronic money management account of user B (arrow ‘o’). Thus, in accordance with the fund transfer instruction, bank accounting system 10 transfers an electronic money amount equivalent to the remittance from the user A's electronic money account due for remittance to the electronic money management account of user B (S21). For example, as shown in FIG. 12, Yen 10,000 is subtracted from the balance in the user A's electronic money account due for remittance which has been increased in step. S16, and is added to the electronic money management account of user. B.

In the embodiment of the present invention having been described, the storage means storing electronic money should not necessarily be limited to the IC card. For example, electronic money may be stored in a portable telephone. In such a case, the portable telephone may also function as a terminal connecting to the Web server (network server) or the electronic money server, not only as a storage means.

In the embodiment of the present invention, the electronic money server and the Web server (network server) may be integrated as a single server.

### INDUSTRIAL APPLICABILITY

As having been described, according to the present invention, electronic money remittance between electronic money users may be achieved even in a closed-loop electronic money system by the use of an electronic mail.

The foregoing description of the embodiments is not intended to limit the invention to the particular details of the examples illustrated. Any invention and equivalents which are covered by the appended claims may be embraced to the scope of the invention.

What is claimed is:

1. An electronic money remittance method for remitting electronic money from a first user to a storage means storing electronic money of a second user, comprising:
receiving predetermined remittance order information from a terminal for use by the first user;
generating a program for depositing an electronic money amount equivalent to the remittance in the storage means of the second user based on the remittance order information, and subtracting the amount equivalent to the remittance from a predetermined account balance related to the first user;
transmitting the program to a terminal for use by the second user;
receiving a remittance instruction transmitted from the terminal for use by the second user as a consequence that the program received by the terminal for use by the second user is executed by said terminal; and
depositing an electronic money amount equivalent to the remittance by accessing the storage means of the second user connected to the terminal for use by the second user according to the remittance instruction, and adding the amount equivalent to the remittance to an electronic money management account balance related to the electronic money stored in the storage means of the second user.

2. The electronic money remittance method according to claim 1,
wherein the electronic money balance stored in the storage means of each user is managed in the electronic money management account either separately on a per storage means basis or collectively.

3. The electronic money remittance method according to claim 1,
wherein,
an electronic money account due for remittance is opened;
the remittance amount subtracted from a predetermined account balance of the first user is transferred to the electronic money account due for remittance; and
according to the remittance instruction, the remittance is transferred from the electronic money account due for remittance to the electronic money management account.

4. The electronic money remittance method according to claim 1,
wherein,
when the first user owns a storage means storing electronic money, an electronic money amount equivalent to the remittance is subtracted from the electronic money management account balance related to the electronic money stored in said storage means of the first user; and
further, the storage means of the first user connected to the terminal for use by the first user is accessed, and an electronic money amount equivalent to the remittance is paid out from said storage means.

5. The electronic money remittance method according to claim 1,
wherein, when the first user does not own any storage means storing electronic money, an amount equivalent to the remittance is subtracted from a bank account balance of the first user.

6. The electronic money remittance method according to claim 1,
wherein the storage means is an IC card.

7. The electronic money remittance method according to claim 6,
wherein the remittance order information includes identification information of the IC card of the second user, and the remittance amount.

8. The electronic money remittance method according to claim 7,
wherein the identification information of the IC card of the second user is a card number of said IC card.

9. The electronic money remittance method according to claim 7,
wherein,
the identification information of the IC card of the second user is an electronic-mail address of the second user; and
the electronic money system includes a mapping table between the IC card number of each user and the electronic mail address, and obtains the IC card number of the second user based on said mapping table.

10. The electronic money remittance method according to claim 1,
wherein the program is attached to an electronic mail and transmitted to the terminal for use by the second user.

11. An electronic money system for remitting electronic money from a first user to a storage means storing electronic money of a second user, comprising:
a network server connecting to a terminal for use by a first user and a terminal for use by a second user through a network; and
an electronic money server managing electronic money of each user,
wherein,
the network server receives remittance order information generated in the terminal for use by the first user;
based on the remittance order information, the electronic money server generates a program for depositing an electronic money amount equivalent to the remittance in the storage means of the second user, and subtracts an amount equivalent to the remittance from a predetermined account balance related to the first user;
the network server transmits the program to the terminal for use by the second user; and
according to a predetermined remittance instruction which is transmitted from the terminal for use by the second user as a consequence that the program received by the terminal for use by the second user is executed by said terminal, the electronic money server accesses the storage means of the second user connected to the terminal for use by the second user, deposits an electronic money amount equivalent to the remittance, and adds the amount equivalent to the remittance to an electronic money management account balance related to the electronic money stored in the storage means of the second user.

12. A program executable in a terminal for use by the second user to remit electronic money from a first user to a storage means storing electronic money of a second user, said program comprising the processing steps of:
enabling an electronic money server to access the storage means of the second user connected to the terminal for use by the second user, and to deposit an electronic money amount equivalent to the remittance, and generating a remittance instruction for adding the amount equivalent to the remittance to an electronic money management account balance related to the electronic money stored in the storage means of the second user; and
transmitting the remittance instruction to the electronic money server through a network.

13. An electronic money server for remitting electronic money from a first user to a storage means storing electronic money of the second user, comprising:
a first processing section which generates a program for depositing an electronic money amount equivalent to the remittance in the storage means of the second user, and subtracts the amount equivalent to the remittance from a predetermined account balance related to the first user, based on remittance order information generated in a terminal for use by the first user; and
a second processing section which accesses the storage means of the second user connected to a terminal for use by the second user, deposits an electronic money amount equivalent to the remittance according to a remittance instruction which is transmitted from the terminal for use by the second user as a consequence that the program received by the terminal for use by the second user is executed by said terminal, and adds the amount equivalent to the remittance to an electronic money management account balance related to the electronic money stored in the storage means of the second user.

14. A terminal for use by a first user, performing a processing for electronic money remittance from the first user to a storage means of a second user, comprising:
a display unit which displays a remittance order information generation screen for remitting electronic money; and
a communication section which transmits through a network the remittance order information generated according to the remittance order information generation screen to an electronic money server managing electronic money of each user.

15. A terminal for use by a second user, performing a processing for electronic money remittance from a first user to a storage means of the second user, comprising:
a communication section which receives, from an electronic money server managing electronic money of each user, a program for depositing an electronic money amount equivalent to the remittance into the storage means of the second user; and
an execution section which executes the program, wherein, by executing the program by the execution section, the communication section enables the electronic money server to access the storage means of the second user connected to the terminal, and deposit the electronic money amount equivalent to the remittance, and the communication section transmits, to the electronic money server through a network, a remittance instruction for adding the amount equivalent to the remittance to an electronic money management account balance related to the electronic money in the storage means of the second user.
